(19) United States
(12) Patent Application Publication
(10) Pub. No.: US 2006/0171135 A1
(43) Pub. Date: Aug. 3, 2006

(54) Light emitting apparatus

(75) Inventors: Mitsunori Ishizaka, Minamitsuru-gun (JP); Hirohiko Ishii, Minamitsuru-gun (JP)

Correspondence Address: BROWDY AND NEIMARK, P.L.L.C.;624 NINTH STREET, NW, SUITE 300, WASHINGTON, DC, 20001-5303, US

(73) Assignee: Citizen Electronics Co., Ltd., Fujiyoshida-shi (JP)

(21) Appl. No.: 11/332,469

(22) Filed: Jan. 17, 2006

(30) Foreign Application Priority Data
Jan. 17, 2005 (JP) P 2005-008892
Nov. 30, 2005 (JP) P 2005-346598

(51) Int. Cl. G03B 15/02

(52) U.S. Cl. 362/11; 362/249

(57) ABSTRACT

A light emitting apparatus including one diode package, the diode package including a plurality of LED chips connected in parallel with an anode side common electrode and a cathode side common electrode, the plurality of LED chips being set so that a voltage is applied to each of the LED chips in a forward direction.

### CROSS-REFERENCE TO RELATED APPLICATIONS

This application is based on and claims priority from Japanese Patent Application Nos. 2005-8892 filed on Jan. 17, 2005 and 2005-346598 filed on Nov. 30, 2005, the contents of which are incorporated herein by reference in their entirety.

### BACKGROUND OF THE INVENTION

1. Field of the Invention

The present invention relates to a light emitting apparatus using a light emitting diode (LED) chip, more specifically to a light emitting apparatus used mainly as a flash for a compact camera or the like.

2. Description of Related Art

In recent years development has proceeded of a high-capacity LED configured to emit uniform and strong light as used for a liquid crystal display; in particular, a high-capacity white power diode has come to be used as a flash for a compact camera or the like because it shows no variations in color.

In forming a high-capacity power diode, the volume of light from a single LED chip is insufficient, and an increased light volume has often been accomplished by use of a plurality of LED chips.

Increased light volume through the use of a plurality of LED chips as a light emitting apparatus can be achieved by using a structure in which the LED chips are connected in parallel and a structure in which the LED chips are connected in series.

FIG. 4 illustrates a connecting diagram of a conventional series type light emitting apparatus 300 in which LED chips are connected in series.

The series type light emitting apparatus 300 includes one current-limiting resistor 301 and a plurality of serially connected LED chips 302a, 302b . . . 302n connected to the current-limiting resistor 301.

An anode side electrode 303 is connected to the current-limiting resistor 301, and a cathode side electrode 304 is connected to the LED chips 302a, 302b . . . 302n. Moreover, a positive terminal of a voltage source outputting a voltage higher than a sum of forward voltages of the LED chips is connected to the anode side electrode 303 and a negative terminal of the voltage source is connected to the cathode side electrode 304. By applying a voltage to the LED chips 302a, 302b . . . 302n which are connected in series through the voltage source, the same current limited by the current-limiting resistor 301 is applied to each of the serially connected LED chips 302a, 302b . . . 302n, and all the LED chips 302a, 302b . . . 302n are lighted simultaneously.

FIG. 5 illustrates a connecting diagram of a conventional series type light emitting apparatus 400 with control for emission, in which LED chips are connected in series and the emission is electronically controlled.

The series type light emitting apparatus 400 with the control for emission includes a current-limiting resistor 401 and a plurality of serially connected LED chips 402a, 402b . . . 402n connected to the current-limiting resistor 401, and anode and cathode side electrodes 403 and 404, in the same way as with the structure shown in FIG. 4. A light emitting control transistor 405 is connected between a cathode of the LED chip 402n and the cathode side electrode 404. Here, reference number 406 shows a control terminal of the light emitting control transistor 405.

In the same way as with the structure shown in FIG. 4, by applying a voltage higher than a sum of LED chips' forward voltages to the LED chips through a voltage source and applying a conducting signal to the control terminal 406 of the light emitting transistor 405, the same current limited by the current-limiting resistor 401 is applied to each of the serially connected LED chips 402a, 402b . . . 402n, and all the LED chips 402a, 402b . . . 402n are lighted simultaneously.

However, in the above-mentioned conventional light emitting apparatuses for achieving increased light volume by connecting the plurality of LED chips in series, if just one of the serially connected LED chips fails to light up due to faulty connection, there is a problem that all the serially connected LED chips will consequently fail to light up because the LED chips are connected in series.

FIG. 6 illustrates a connecting diagram of a parallel type light emitting apparatus 500 in which a plurality of LED chips are connected in parallel.

The parallel type light emitting apparatus 500 includes current-limiting resistors 501a, 501b, 501c . . . 501n, LED chips 502a, 502b, 502c . . . 502n connected with the current-limiting resistors 501a, 501b, 501c . . . 501n, respectively, an anode side electrode 503, and a cathode side electrode 504.

Here, because the LED chips 502a, 502b, 502c . . . 502n have different forward voltages VF, n current-limiting resistors and n LED chips are respectively connected in series independently, and a current limited by their current-limiting resistors is applied to their LED chips by applying a positive voltage to the anode side electrode 503 and a negative voltage to the cathode side electrode 504, thereby all the LED chips are lighted simultaneously. Here, independent “n” shows number of pieces.

In the light emitting apparatuses, the LED chips are generally connected by bonding wires or flip chip bonding using bumps and it is occasionally the case that at least one bonding wire or bump becomes disconnected resulting in failure of at least one LED chip.

Explaining this condition through FIG. 4, if a failure occurs in the LED chip 302b of the plurality of LED chips 302a, 302b . . . 302n, no current is applied to each of the LED chips 302a, 302b . . . 302n due to the failure of the LED chip 302b because the LED chips 302a, 302b . . . 302n are connected in series, thereby all the LED chips 302a, 302b . . . 302n are unlighted.

Alternatively, in the light emitting apparatuses for achieving increased light volume by connecting the plurality of LED chips in parallel, there is a problem that it is troublesome to have to connect current-limiting resistors 501a, 501b, 501c . . . 501n to each of the LED chips 502a, 502b, 502c . . . 502n, respectively, requiring a large number of resistors.

### SUMMARY OF THE INVENTION

An object of the present invention is to provide a light emitting apparatus in which a plurality of LED chips are connected in parallel to achieve increased light volume of the light emitting apparatus, where the light emitting apparatus can remain lighted even if a failure occurs in one or more LED chips and where a minimum of current-limiting resistors are required to accomplish effective function of the light emitting apparatus thereby reducing the cost of parts.

To accomplish the above-mentioned object, a light emitting apparatus according to one embodiment of the present invention comprises one diode package. The one diode package includes a plurality of LED chips connected in parallel to an anode side common electrode and a cathode side common electrode.

A forward voltage to be applied to each of the LED chips in one package is selectively coordinated. In other words, LED chips are previously selected.

In addition, variations of the forward voltages of the LED chips in one package are configured to be selectively set beforehand in the range of 0.1 V or less.

### BRIEF DESCRIPTION OF THE DRAWINGS

FIG. 1 is a plan view showing a first embodiment of a light emitting apparatus according to the present invention, including a diode package in which a plurality of LED chips are connected in parallel.

FIG. 2 is an interior connecting diagram of the diode package shown in FIG. 1.

FIG. 3 is a structural view showing a second embodiment of the light emitting apparatus according to the present invention.

FIG. 4 is a connecting diagram of a conventional light emitting apparatus in which LED chips are connected in series.

FIG. 5 is a connecting diagram of a conventional light emitting apparatus in which LED chips are connected in series and the emission of the diode chips is electronically controlled.

FIG. 6 is a connecting diagram of a conventional light emitting apparatus in which a plurality of LED chips with a plurality of current-limiting resistors are connected in parallel.

### DETAILED DESCRIPTION OF THE PREFERRED EMBODIMENTS

Preferred embodiments of the present invention will be explained in detail below with reference to the accompanying drawings.

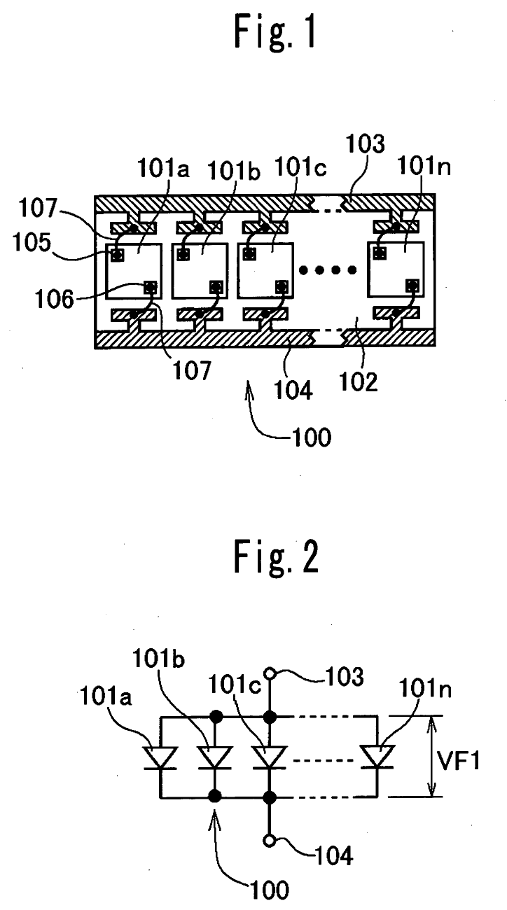

FIGS. 1 and 2 illustrate a first embodiment of a light emitting apparatus according to the present invention. The light emitting apparatus includes one diode package 100 as shown in FIGS. 1 and 2. The diode package 100 has a substrate 102 and a plurality of LED chips 101a, 101b, 101c . . . 101n mounted on the substrate 102 (see FIG. 1). The LED chips 101a, 101b, 101c . . . 101n are connected in parallel to an anode side common electrode 103 and a cathode side common electrode 104 (see FIG. 2).

More specifically, each of the LED chips 101a, 101b, 101c . . . 101n has an anode 105 connected to the anode side common electrode 103 and a cathode 106 connected to the cathode side electrode 104, through bonding wires 107, respectively (see FIG. 1). Of course, instead of using bonding wires 107, bumps may be used for electric connection.

Consequently, the diode package 100 is configured to form one diode package in which the LED chips 101a, 101b, 101c . . . 101n are connected in parallel on the substrate 102.

Each of the plurality of LED chips 101a, 101b, 101c . . . 101n connected in parallel on the substrate 102 so as to form the one diode package is set beforehand so that a voltage is applied in a forward direction. When a plurality of LED chips are used in one light emitting apparatus, luminance variations of the LED chips can be avoided by selectively coordinating a forward voltage to be applied to the LED chips.

In other words, a plurality of LED chips are selected in accordance with a desired forward voltage. Generally, a plurality of LED chips are simultaneously manufactured as an assembly, and for example, a forward voltage VF of each of the LED chips may be measured at wafer level after scribing the wafer assembly. Here, scribing is the term used to indicate a process for dividing the wafer assembly into individual LED chips, as is well known.

In the case of selective application of the forward voltage to each of the plurality of LED chips, if a variation range in the forward voltages VF is sorted to within 0.01V, variations in current among the plurality of LED chips to be mounted on the same substrate are 1 mA or less which is negligible, but this results in poor yield and is impractical.

Also, it has been found that in one example of a manufacturing process, even if the selected variation range in the forward voltage VF of each LED chip is reduced to 0.1 V, the variation in current of each LED chip in one diode package is 3 mA or less. This result is under the stated conditions here; the diode package having a structure in which eight LED chips are connected in parallel and driven by applying 350 mA, and when the selection of each forward voltage VF is carried out by applying the driving current of about 44 mA for a pulse width of 10 msec per element of each LED chip constituting the diode package.

It is also known that the rate of light intensity deterioration after 40,000 hours (in comparison with the initial light intensity) for the diode package including the eight LED chips in which the variation range in the forward voltages VF of the diode chips is previously selected under the sorting conditions of 0.1 V or less can be limited to 50% or less. Also, it is known that no significant difference has been established between the effectiveness of this diode package and a diode package in which variations in forward voltages VF are previously set as 0.01V or less which is a stricter sorting condition. Consequently, the advantageous effect of increasing improvements in yield can be obtained by relaxing the sorting condition, and the sorting condition of the forward voltages VF may be set to the practical level of 0.1V.

From the above, if a forward voltage of the diode package 100 formed by the LED chips in which the forward voltages are aligned is VF1, the diode package 100 may include a plurality (here n) of LED chips, but it is possible to treat the diode package 100 as one LED chip.

Moreover, even if one or more LED chips 101a, 101b, 101c . . . 101n which are connected in parallel become disconnected at the bonding wires or connection portions of the LED chips, because other connected LED chips can remain lighted, the aligned forward voltage VF1 with respect to the anode and cathode side common electrodes is preserved.

In other words, by structuring the diode package 100 as one package in which the plurality of LED chips are connected in parallel, even if a faulty connection occurs in one or more of the LED chips connected in parallel, the forward voltage VF1 of the residual non-defective LED chips allows the diode package 100 to continue functioning as a light emitting apparatus. Therefore, it is possible to provide a light emitting apparatus having high reliability, easy manipulation and in which it is well-designed against lighting failure due to a fault in the LED chips, thereby maintaining the luminous function and conducting route of the light emitting apparatus.

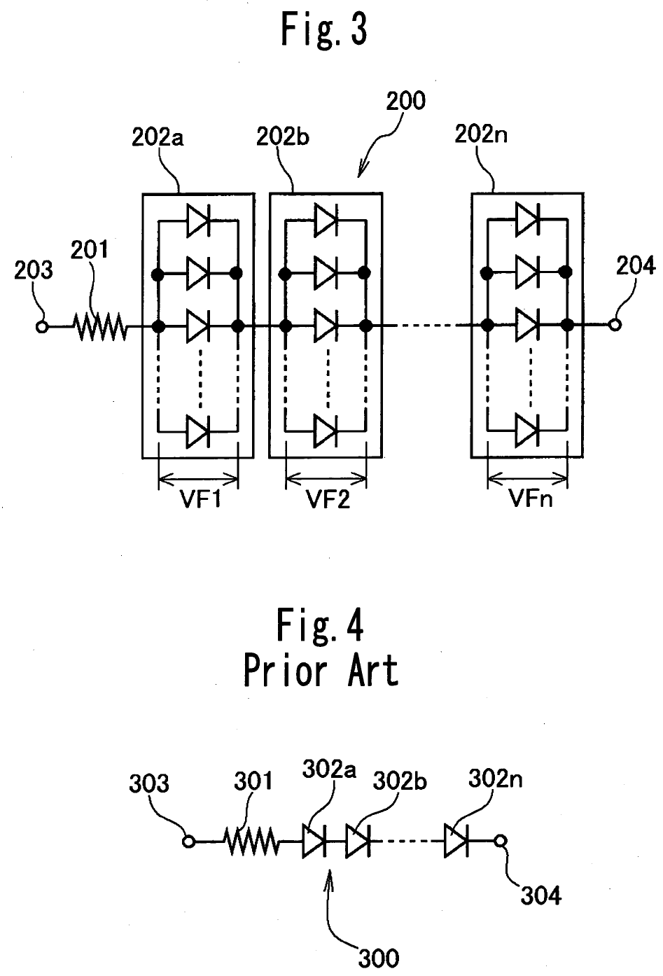

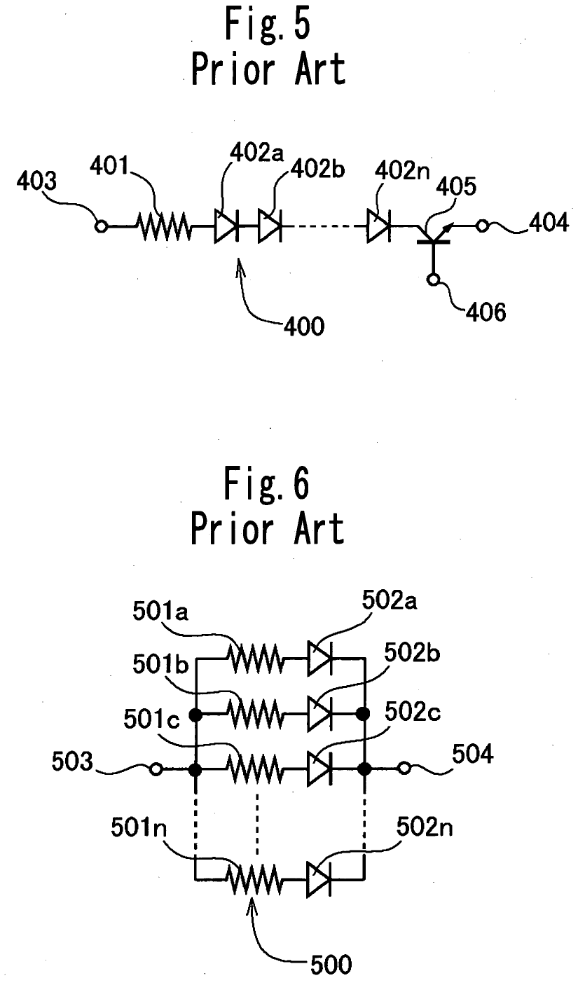

FIG. 3 illustrates a second embodiment of a light emitting apparatus according to the present invention.

The light emitting apparatus 200 as shown in this second embodiment includes a plurality of diode packages 202a, 202b . . . 202n which are connected in series, one current-limiting resistor 201 connected in series to the diode packages 202a, 202b . . . 202n, anode and cathode side common electrodes 203 and 204 which are connected in series to an assembly of the diode packages 202a, 202b . . . 202n and the current-limiting resistor 201.

Each of the diode packages 202a, 202b . . . 202n has a similar structure to the diode package 100 mentioned in detail in FIGS. 1 and 2. More specifically, each of the diode packages 202a, 202b . . . 202n has one substrate and a plurality of LED chips in each diode package mounted on each substrate. In this case, the individual diode packages are previously prepared, and the prepared diode packages are electrically connected.

In FIG. 3, the LED chips are selected and set so that variations in forward voltages VF of the LED chips in each diode package are eliminated.

That is to say, the forward voltages of the diode packages 202a, 202b . . . 202n have different values VF1, VF2, VF3 . . . VFn, while the forward voltages VF of the LED chips in each diode package are previously selected and aligned at the chip level as mentioned above.

In other words, by connecting positive and negative terminals of a voltage source (not shown) outputting a voltage higher than a sum of the forward voltages VF1, VF2, VF3 . . . VFn of the diode packages 202a, 202b . . . 202n with the anode and cathode side common electrodes 203 and 204, respectively, and applying the voltage to the diode packages, the same current limited by the current limiting resistor 201 is applied to each of the diode packages 202a, 202b . . . 202n connected in series, and the entirety of diode packages 202a, 202b . . . 202n are lighted simultaneously.

Consequently, even if one or more LED chips which are connected in parallel and disposed in each of the diode packages 202a, 202b . . . 202n which constitute the light emitting apparatus 200 for illumination and are connected in series become disconnected, for example, at bonding wire portions or connecting portions of the LED chips, the residual non-defective LED chips remain lighted, and each of the diode packages 202a, 202b . . . 202n continues to function as an LED package. Therefore, because the forward voltages VF with respect to the anode and cathode common electrodes 203 and 204 do not vary, it is possible to provide a light emitting apparatus having a high reliability, easy manipulation and in which it is well-designed against lighting failure due to a fault in the LED chips, thereby maintaining the luminous function and conducting route of the light emitting apparatus.

In addition, because the plurality of LED chips can be treated as one diode package or unit, they are compatible with the conventional series type and parallel type light emitting apparatus.

As mentioned above, the present invention makes it possible to provide a light emitting apparatus in which lighting failure as a light emitting apparatus can be prevented, thereby assuring high reliability even in the event of failure of one or more LED chips.

Although the preferred embodiments of the present invention have been mentioned, the present invention is not limited to these embodiments, and various modifications and changes can be made to the embodiments.

What is claimed is:

1. A light emitting apparatus, comprising:
one diode package,
wherein the diode package includes a plurality of light emitting diode chips electrically connected in parallel to an anode side common electrode and a cathode side common electrode, and
wherein the plurality of light emitting diode chips are selectively set so that a forward voltage is applied to each of the light emitting diode chips to avoid luminance variations.

2. The light emitting apparatus according to claim 1,
wherein the one diode package has a substrate, and
the light emitting diode chips are mounted on the substrate.

3. The light emitting apparatus according to claim 1,
wherein each of the plurality of light emitting diode chips has an anode and a cathode connected to the anode side common electrode and the cathode side common electrode, respectively.

4. The light emitting apparatus according to claim 1,
wherein the plurality of light emitting diode chips are set so that variations in the forward voltages of the light emitting diode chips are within a range of 0.1 V or less.

5. A light emitting apparatus, comprising:
a plurality of diode packages; and
one current restricting resistance connected in series to the plurality of diode packages,
wherein each of the plurality of diode packages has a structure in which a plurality of light emitting diode chips are connected in parallel.

6. The light emitting apparatus according to claim 5,
wherein each of the plurality of diode packages has a substrate, and
wherein the plurality of light emitting diode chips are mounted on each substrate.

7. The light emitting apparatus according to claim 5,
wherein each of the plurality of diode packages has the same number of light emitting diode chips.

8. The light emitting apparatus according to claim 5,
wherein the plurality of diode packages are previously selected so that a forward voltage is applied to the plurality of light emitting diode chips to avoid luminance variations.

9. The light emitting apparatus according to claim 5,
wherein the plurality of light emitting diode chips are set so that the forward voltage variations of the light emitting diode chips are within a range of 0.1 V or less.
